(19) United States
(12) Patent Application Publication
(10) Pub. No.: US 2019/0283860 A1
(43) Pub. Date: Sep. 19, 2019

(54) THREE-DIMENSIONAL METAL INSULATING PART

(71) Applicant: Hutchinson, Paris (FR)

(72) Inventors: Fabrice Chopard, Saint Martin D'heres (FR); Mathieu Leborgne, Montargis (FR); Cédric Huillet, Montargis (FR); Thomas Patillaut, Melleroy (FR); Hmad Bourass, Amilly (FR); Yann Favier, Dommartin (FR); Christophe Dominiak, Varennes Changy (FR)

(73) Assignee: Hutchinson, Paris (FR)

(21) Appl. No.: 15/781,054

(22) PCT Filed: Dec. 2, 2016
(86) PCT No.: PCT/FR2016/053188

§ 371 Date: Jun. 1, 2018

(30) Foreign Application Priority Data
Dec. 2, 2015 (FR) 1561727

(51) Int. Cl. B64C 7/02; F01D 25/08; B32B 1/02; B32B 3/06; B32B 3/04; B32B 7/08; B32B 7/05; B32B 15/01; B32B 5/18; B32B 5/02; B32B 15/04; B32B 15/14; B32B 37/18; B32B 37/06; B23K 20/00; B23K 20/227; B23K 20/233; B23K 20/26; B23K 15/00; F16L 59/02; F16L 59/065

(52) U.S. Cl. CPC B64C 7/02; B23K 20/023; B32B 1/02; B32B 3/06; B32B 3/04; B32B 7/08; B32B 7/05; B32B 15/016; B32B 15/011; B32B 5/18; B32B 5/02; B32B 15/046; B32B 15/14; B32B 37/18; B32B 37/06; B23K 20/002; B23K 20/227; B23K 20/2336; B23K 20/26; B23K 15/006; F16L 59/021; F16L 59/065; F05D 2220/323; B32B 2305/026; B32B 2305/022; B32B 2307/304; B32B 2307/7242; B32B 2250/40; B32B 2262/101; B32B 2262/108; B32B 2266/0278; B32B 2266/06; B32B 2266/126; B32B 2307/732; B32B 2605/08; B32B 2605/12; B32B 2605/18; B32B 2311/24; B32B 2311/30; F01D 25/08

(57) ABSTRACT

The invention relates to the thermal creation of a part, including steps of: using at least one first and one second metal plate (30, 31), hollow-forming the first plate so as to form at least part of said inner wall, and hollow-forming the second plate (31) so as to form at least part of said outer wall. During the forming, the shapes of the first and second plates are adjusted such that they can be placed in contact with each other while leaving a space therebetween inside said periphery, and then the first and second plates are placed in a low-pressure and/or controlled-atmosphere chamber (65), where said plates are brought together and peripherally sealed together such that, in said space, a low-pressure and/or controlled-atmosphere enclosure is created.

The present invention relates to the field of thermal management.

It relates, in particular, to an insulating part in a controlled atmosphere (especially a vacuum insulated part or VIP (vacuum insulated panel)) and the method for manufacturing same.

Patent publications such as U.S. Pat. No. 9,157,230 have already addressed these matters. A problem subsists, however, in connection with the performance of the panel over time, and thus the reliability thereof and its effectiveness in the thermal management of the environment in which it is placed, all the more so if this environment is governed by strict standards, as in the naval or automotive industries.

Without specifically citing the critical fields of use, U.S. Pat. No. 9,157,230 proposes a VIP panel provided to reduce the leakage of heat with regard to a structure facing which the panel is arranged.

However, the described manufacturing method imposes a restricting implementation that is not justified in the eyes of the inventors since it does not make it possible, in their opinion, to guarantee a lifespan of a decade or multiple decades for the panel under satisfactory operational conditions.

One aspect of the invention aims to address this problem, which becomes critical when a defect in thermal management quality is not acceptable during years, in a difficult environment: considerable thermal stress around an engine, risk of chemical or mechanical attacks during maintenance, consecutive cycles of applied thermal stress, in an often harsh vibrational environment.

There exist, furthermore, methods for producing parts which have inner walls that are at least locally concave and outer walls that are at least locally convex, respectively, said methods contemplating:
the use of at least one first and one second metal plates,
and hollow-forming in particular of one of these metal plates so as to constitute at least one portion of the inner or outer wall of the finished part or a blank of same.

However, to the knowledge of the inventors, such parts are not intended to be used as thermal insulation parts under a controlled atmosphere in terms of pressure and/or composition.

In fact, here it is considered that one obstacle consists of how these parts are produced, in particular if the aim is for them to integrate a sleeve with low pressure designed to last for a decade, especially in an industrial environment (motor vehicle industry, naval industry, etc.).

The invention also proposes a manufacturing method that comprises the following steps:
hollow-forming the first metal plate to constitute at least one portion of the inner wall of the finished part or of a blank thereof,
hollow-forming the second metal plate to constitute at least one portion of the outer wall of the finished part or of a blank thereof,
   with, among other specific features, that:
the hollow-forming of the first metal plate is internally at least locally concave on the inside (and externally at least locally convex) so as to constitute at least one portion of said inner wall,
the hollow-forming of the second metal plate is externally at least locally convex (and internally at least locally concave) so as to constitute at least one portion of said outer wall,
wherein the cavity of the first metal plate is placed inside the cavity of the second plate, in order to define a double-walled bowl,
during forming, the shapes of the first and second metal plates are adjusted such that they can be placed in contact with one another, peripherally, while leaving a space therebetween, inside said periphery,
then the first and second metal plates are preferably placed in a chamber with low pressure and/or controlled atmosphere, in which they are brought together and welded together, peripherally, such that an enclosure with low pressure and/or controlled atmosphere is created between them in said space.

It follows that at least one portion of the aforementioned welding can be made outside the chamber with low pressure and/or controlled atmosphere.

In the present application:
“low pressure” refers to a pressure that is lower than the ambient pressure (thus <10⁵ Pa). A pressure between 10⁰ Pa and 10⁴ Pa inside the enclosure may, in particular, be convenient;
“controlled atmosphere” refers to being filled with a gas having lower thermal conductivity than that of the ambient air (26 mW/m·K),
“welding” excludes all brazing, in accordance with the recognised meaning in the prior art. In the welding provided herein, no filler material is used and/or the assembled edges are not fused. In the rest of the text, all sealing will, in principle, be welding. The welding will be continuous (and thus not spot welding).

Metal plates with thicknesses less than or equal to 3 mm, and typically thicknesses of 0.07 mm to 3 mm, especially with materials chosen from the group that comprises stainless steel, aluminium and other metals with thermal conductivity of less than 300 W/m·K, will make it possible:
to combine the overall thermal conductivities of the part and the intrinsic thermal conductivity of the plates, since thermal diffusion and thermal losses will then be low,
and to satisfy mechanical resistance requirements comparable to those of 7 mm thick solid-wall oil casing made of aluminium.

In the present document, all thermal conductivity is considered to be estimated at 20° C., in an environment at atmospheric pressure.

In order to increase the effectiveness of the insulation, or the mechanical strength thereof, it is proposed that, prior to the step of producing the enclosure with low pressure and/or controlled atmosphere, a core material or a heat-reflective screen is arranged between the two metal plates.

In the case of a core material, and especially when seeking to constitute a structuring element for supporting plates against the low pressure inside the enclosure, before sealing the shaped plates together, said core material will be moulded substantially to the shapes of the inner and outer walls of these first and second plates, respectively.

Performed in a chamber with low pressure relative to the outside environment or under a controlled atmosphere, the welding will preferably have a leakage rate of less than 10⁻⁶ Pa·m³/s, after a first thermal treatment according to standard RTCA-DO 160-G section 5 Cat A (from −55° C. to 400° C.) and a second thermal treatment at −196° C. during 1 hour.

It is noted above that, in relation to standard RTCA-DO 160-G section 5 Cat A, the maximum temperature of the test was reduced from 550° C. to 400° C.

And, preferably, leakage rates at the weld must be identical (to within 20%) before applying the test according to the standard and after.

In order to facilitate the obtention of such a leakage rate of less than 10⁻⁶ Pa·m³/s, it is furthermore proposed for at least one of these metal plates to have, at the seal:
at least one fold, such as a double fold, onto itself,
and/or a lining, or a structure that can mechanically comprise or consist of a structuring frame, preferably made of metal, in order to then perform assembly by welding.

In both cases, this will be prepared at the seal, by clamping the edges of the plates together, and not at the outer periphery of the sheets, on a remaining side, as in U.S. Pat. No. 9,157,230.

It has also been noted that by using grained plates to produce the sleeve, a material deformation reserve will be obtained which is useful in particular for the fold areas (to prevent tearing during forming) or for absorbing at least a portion of the deformations of the walls of the sleeve, especially due to thermal stress.

An alternative to graining as in FIG. 10 below, may consist of providing at least one concertina area that can be extended under a certain amount of effort.

As regards the forming of the first and second metal plates, incremental forming (ISF) guarantees manufacturing that is compatible with the sought lifespans of a decade and beyond.

For example, in an automotive application, where it is necessary to attach the obtained part to an engine part, such an attachment may be delicate, considering the atmosphere to be preserved inside the enclosure and the various constraints: vibrations, spraying, possible maintenance, etc.

It is also proposed for the metal walls forming the enclosure of the part to be surrounded by an attachment flange that comprises a mechanically reinforced structure, such as a frame:
located at least locally around the seal between the metal walls,
and which will receive, around said seal, means for connecting with the structure (engine part or other) on which the part is mounted in order to be attached.

The attachment flange may have an increased material thickness compared with the thickness of the metal walls, in order to define the mechanically reinforced structure and/or the seal between the metal walls.

As regards at least one of the metal plates forming the walls folding onto itself, it may constitute at least one portion of said reinforced structure, providing an increased material thickness.

Beyond the production of a double-walled hollow part, the invention also provides for producing a structure:
wherein a plurality of such thermally insulating parts are made, each part being made in a double-walled bowl according to the method above,
and then, once said parts have been sealed, at least two so-called sealed parts are assembled together, arranging them facing one another to produce the structure, which then comprises an inner volume, between the double walls.

Each thermal insulation part will thus comprise an airtight sleeve defining an inner enclosure with low pressure relative to the outside environment or with controlled atmosphere. The part will advantageously have a thermal conductivity of less than 100 mW/m·K (at 20° C. and in an environment at atmospheric pressure), the airtight sleeve then comprising inner and outer metal walls, respectively, hollow-formed and sealed together peripherally in order to maintain the enclosure with low pressure or with a controlled atmosphere, said metal walls being arranged with one cavity inside the other, so as to jointly define a double-walled bowl.

The use of such parts, or assembled structures, for producing at least one portion of a casing for receiving a fluid, in particular oil, between −50° C. and 15° C. (when the fluid is cold) or between 50° C. and 300° C. (when the fluid has become hot), is provided for, likewise for producing at least one portion a calorie store for a naval or automotive propulsion engine, and likewise for producing at least one portion of an aircraft engine nacelle comprising an inner fixed structure (IFS) provided with a plurality of such insulating parts, at least some of which have curved shapes.

A further application may relate to the production of a heat exchanger or a storage tank:
subject to a temperature of −150° C. to −273° C. and to a temperature difference of more than 100° C. between an internal volume and an outside environment,
and comprising at least one such insulating part having all or part of the aforementioned features.

If necessary, the invention will be better understood and other characteristics, details and advantages thereof will become apparent upon reading the following description as a non-exhaustive example with reference to the appended drawings in which:

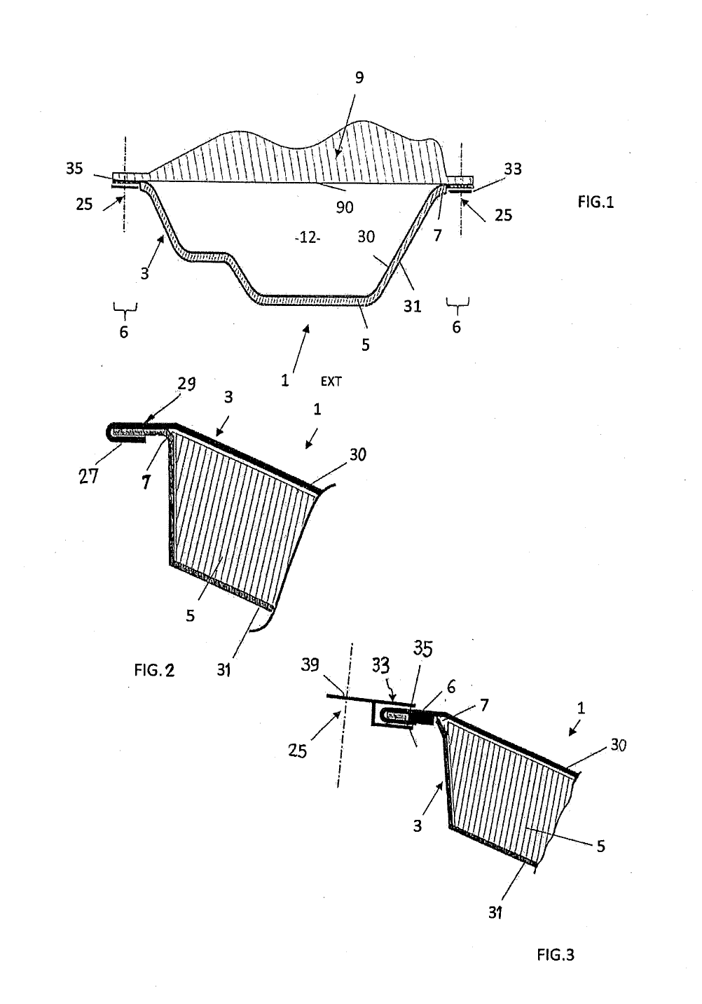

FIG. 1 is a schematic vertical cross-section of an insulating part according to the invention,

FIGS. 2, 3 and 7 are enlarged local views thereof, according to various embodiments;

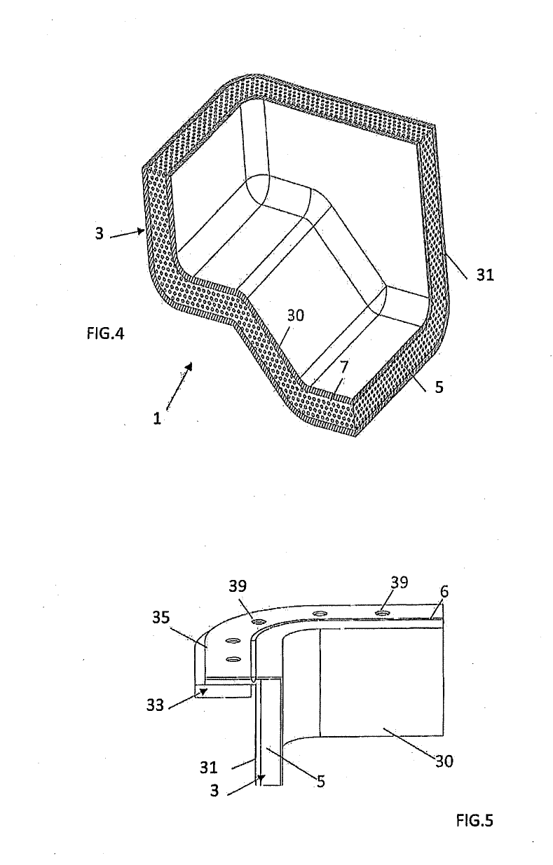

FIG. 4 is a schematic perspective view of another area of the part of FIG. 1;

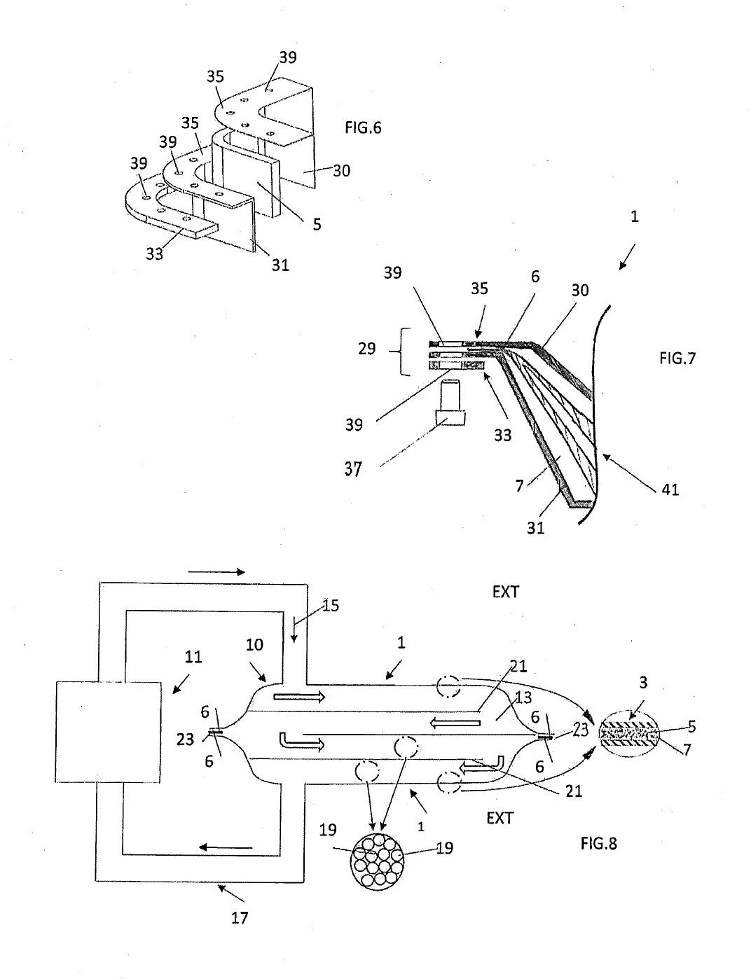

FIGS. 5 and 6 show again the attachment and sealing areas of the part, in an exploded view in FIG. 6;

FIG. 8 is a schematic view of the use of the part for reheating oil on a ship;

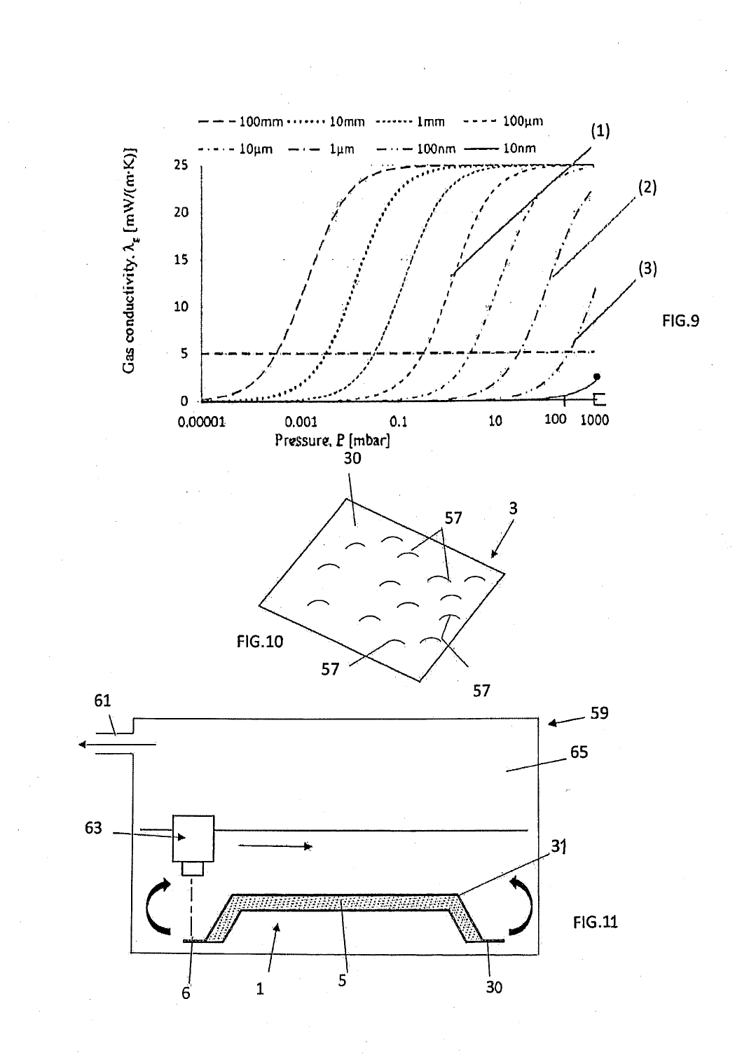

FIG. 9 shows conductivity variation curves (A) as a function of the pressure, for several part cores;

FIG. 10 is a schematic view of metal-plate graining;

FIG. 11 is a schematic view of a chamber with controlled atmosphere containing a device for sealing the perimeter of the insulating part to be produced;

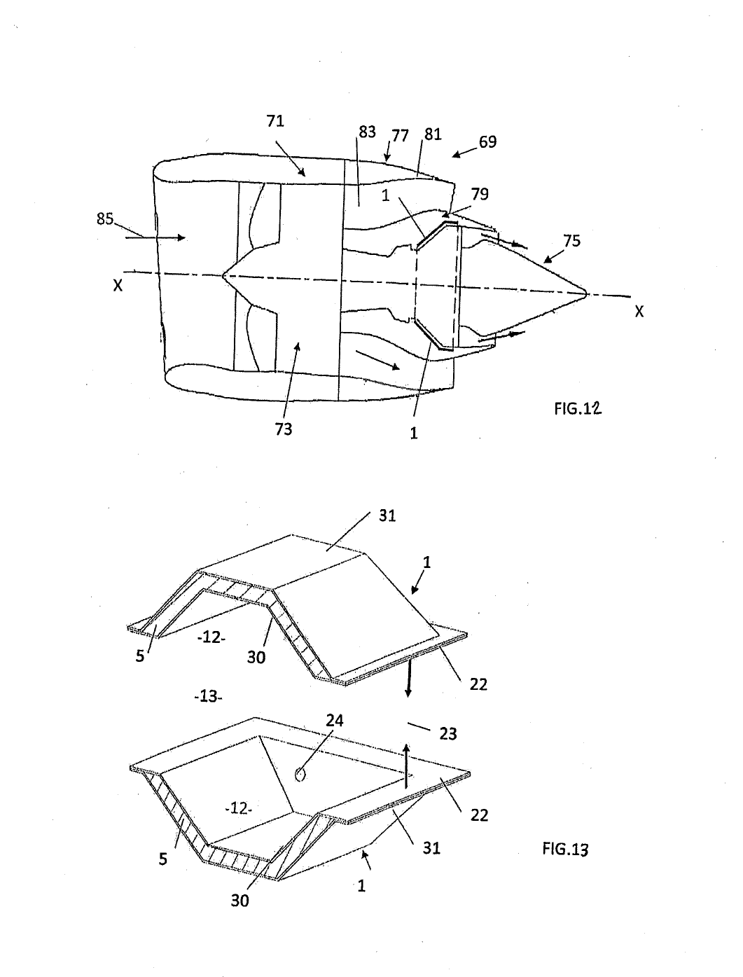

FIG. 12 is a schematic view of an aircraft engine nacelle comprising an inner fixed structure (IFS) provided with a plurality of such insulating parts;

and FIG. 13 shows a tank made up of a plurality of shell portions, in this case two half-shells, to be assembled facing one another.

One aim of the present invention is thus to create a part in a controlled atmosphere (controlled pressure and/or composition), that is hermetically sealed, resistant to perforation, inexpensive, with a long useful life of several years (ten or more years are desirable), with arbitrary size and shape, having high thermal resistance R and thus a high capacity to reduce thermal transfers wherever it is installed.

FIGS. 1-5 show various possible areas of such a thermally insulating part 1, which comprises an airtight sleeve 3 (see leakage rate under examination) defining a closed enclosure 7 with controlled atmosphere having controlled (low) pressure or composition.

The airtight sleeve 3 is defined by metal plates or walls, the inner 30 one of which is at least locally concave and the outer 31 one of which is at least locally convex, sealed together around the entire perimeter of the sleeve, in area 6, in order to maintain the enclosure with low pressure or a controlled atmosphere, as already mentioned. The expression “metal” covers alloys.

The walls 30, 31 each have a thickness of 0.1 mm to 3 mm, typically 1 mm to 3 mm.

These are metal plates chosen from the group comprising stainless steel, aluminium and other metals with thermal conductivity of less than 300 W/m·K.

The controlled atmosphere in the enclosure 7 can consist of the presence of a gas such as CO2.

Additionally or alternatively, the controlled atmosphere can consist of a pressure lower than the atmospheric pressure.

Although the enclosure 7 may not contain any structural elements intended for providing insulation or a thermal barrier, it contains here, as preferred, for the quality of this insulation, a thermal insulator, as in FIGS. 1-6, or a heat-reflective screen, as shown schematically in FIG. 7.

FIGS. 1-3, the thermal insulator is porous and preferably organic or inorganic. This is advantageous for the vacuum to be achieved.

Here, “porous” refers to a material having interstices allowing the passage of air. Open-cell porous materials thus include foams but also fibrous materials (such as glass wool or rock wool). The passage interstices that can be classified as pores have sizes of less than 1 mm or 2 mm so as to be able to guarantee good thermal insulation, preferably less than 1 micron, and preferably still less than 10⁻⁹ m (nanoporous structure), for reasons in particular of mechanical strength and/or resistance to ageing, and thus possibly of less low pressure inside the enclosure.

Among the fibrous insulators, the mineral ones are defined in standard NF B 20-001. Mineral fibrous insulators are grouped into two major families: volcanic rock wools or slag wools and glass wools.

In the embodiment shown schematically in FIGS. 1-6, the thermal insulator defines a structuring core material 5 for the panel 1, i.e. it affects the mechanical strength of the panel.

In this embodiment, the core material 5 is a monolith.

Especially if the core material 5 is structural, the inner plate 30 can be less thick than the outer plate 31, since the effect of the external pressure (EXT) will be supported first by the outer wall 31.

Furthermore, a core material 5 comprising an aerogel will preferably be considered, given its advantages in terms of thermal conductivity, density and mechanical strength, and its capacity for being moulded into complex shapes.

The controlled atmosphere in the enclosure 7 is a major parameter of the part 1 since it allows it to provide the function of thermal superinsulator, if the core material 5 is a thermal insulator, and preferably a micro- or nanoporous insulator, in principle in combination with a low pressure (in relation to the surrounding atmospheric pressure) inside the enclosure 7.

In fact, the combination of an efficient sleeve 3 and a controlled atmosphere, in particular depressurised, inside the enclosure 7 will make it possible to obtain a three-dimensional VIP with long useful life which can be installed in particular in an automobile or on a boat.

In this way, FIG. 1 schematically shows the use of a part 1 as a casing for receiving a fluid, such a lubricant, in particular oil for an engine block 9 of an automotive vehicle. This can be a calorie store 10 inside the inner volume 12 defined by the assembly made up of the bowl-shaped hollow part 1 and an outer wall 90 of the engine block 9 against which the part 1 is then applied.

This is also the application shown schematically in FIG. 8, for a naval propulsion engine 11.

In this application, two parts 1 of the aforementioned type, each with a double wall forming a sleeve 3 sealed peripherally at 6 and with a core material 5, form a housing inside the inner volume 13, with a fluid 15 to be managed thermally (this can also be engine oil) entering from one side thereof, and said same fluid exiting from the other side thereof via a circuit 17 that passes through the engine 11 in which the oil is used. In the volume 13, the fluid 15 can enter into thermal exchange with elements 19 for storing and restoring heat, such as beads, made of solid-liquid phase-change material (PCM). This will be a material such as a paraffin or an acid. The phase-change temperatures will be comprised between −50° C. and 15° C. (for insulation against a cold environment, for example) or between 50° C. and 300° C. (for a naval application, for example, or for insulation against a very hot environment), which excludes the phase-change materials that are preferably used for construction (18° C.-24° C.) and medical applications (35° C.-40° C.).

After, for example, having been charged with hot energy, by liquefying, these elements 19 may subsequently release this energy, for example when starting the engine, in order to preheat the oil of the engine so as to reduce pollutant emissions at that time. Transverse walls 21 inside the inner volume 13 create baffles that promote the thermal exchanges to be carried out.

Attached to a structure of the boat, next to the engine 11, the storage housing 10 is thus closed in a fluid-tight manner 15, by joining various parts 1 that are clamped or attached together peripherally, at 23.

The housing or tank 10 can be produced as shown schematically in FIG. 13, in a plurality of shell portions to be assembled facing one another, in this case two half-shells, each made up of a part 1 according to the invention. In fact, the double-walled hollow part of FIG. 1 can be found several times, in this case twice, preferably with the insertion of a core material 5 (or of a screen 41) between the hollow-formed plates 30, 31. Then, after these shell portions have been arranged with the cavities (inner volumes 12) facing one another, as in FIG. 13, the parts can be attached at 23, typically at the flanges 22 by welding, in order to create the chamber 13 and the expected closed tank.

One or more openings 24 formed in an airtight fashion through one or more of the double walls 30-31 will allow fluid to enter into and/or exit the chamber 13, for example via a tube.

In the automotive application of FIG. 1, the part 1 forming the cosing is attached to (in this case under) the engine block 9, via the attachment means 25. FIGS. 3 to 7 provide details of this aspect.

But first, in FIG. 2 it can be seen that, especially for an application in which weight is a critical parameter, if the thickness of the plates 30, 31 is less than 3 mm per plate (for example, for 304L-type stainless-steel plates), it may be mechanically useful for the plates 30, 31 to be folded onto themselves, for example with a double fold, referenced as 27 in FIGS. 2 and 3, around the entire perimeter of the seal. Thus, the material available for the seal and/or for holding in suspension will be thickened at 29, once the part is attached to its supporting body thereof, in this case the engine block 9.

Another way to create an increased material thickness 29 relative to that of the metal walls 30, 31, with a view to locally defining, on the part 1, a mechanically reinforced structure and/or the seal 6, is to add a frame or frame sections 33.

In both cases, the element 33 will preferably be combined with a flange 35 provided around the entire perimeter of the part 1.

In particular, and as depicted, the metal walls 30, 31 may then each be surrounded by an attachment flange 35 comprising the mechanically reinforced structure thus formed by the frame (or frame sections) 33.

This element 33 will thus be located at least locally around the seal 6. And it will advantageously receive, around said seal, the means 25 for connecting with the body to which it is intended to be attached.

These connection means 25 can comprise removable means, such as screws 37. FIGS. 5-7 only show holes 39 which can pass through the element 33 and the attachment flanges 35, in order to receive the connection means 25 to be attached to the engine block 9, in the example. Seals (not shown) will be provided at these attachments in order not to modify the tightness provided by the sleeve 3.

The alternative imagined in FIG. 3 is a clamp-shaped frame 33 receiving the flange 35 and continuing peripherally by a surface for receiving attachment elements 25 and 39.

In every case, the arrangement of the one or more elements 33 around the seal 6 will make it possible to insulate the attachment of the seal, the quality of which will thus not be affected. The bores 39 will not have any effect on the seal of the enclosure 7.

This is essential, since it has been stated that, in each part 1, the controlled atmosphere with a pressure of less than 10⁵ Pa therein will reduce the gaseous component of the thermal conductivity. However, at a temperature higher than 150° C., the radiative component can have a major influence. This component can be absorbed via the opacity of the material. This absorption depends directly on the Rosseland mean absorption coefficient A of the material (see table below), when the latter comprises at least one porous insulating block:

| | A |
|---|---|
| Composition | (m²/kg) |
| SiO₂ | 22,7 |
| SiO₂ opacified | 84,2 |
| TiO₂ | 32,6 |
| ZrO₂ | 38,9 |
| Carbon | >1000 |
| Resorcinol-formaldehybe (RF) | 50,1 |
| Melamine-formaldehyde (MF) | 47,2 |
| Polyurethane | 47,6 |
| Polystyrene | 47,8 |

Also noted is the interest—in applications in which the temperature substantially reaches or exceeds 150° C.—in the blocks of core material 5 having a Rosseland mean absorption coefficient A no lower than 30.

This is the case of a silica gel, or a silicic acid powder (S102), pressed into a plate, or the pyrolysed carbonaceous composition presented in FR-A-2996850, the evolution λ=f(P) of which is shown in FIG. 9 (curve 2) which is recommended, in the pyrolysate version thereof (see FIG. 9; curve 3), for producing the inner structure 5, in that it is a pyrolysate of an organic polymeric monolithic gel or said gel in the form of a thermally superinsulating porous carbon monolith (i.e. having thermal conductivity less than or equal to 100 mW/m·K, and preferably less than or equal to 26 mW/m·K). Specifically, this pyrolysate is a gelled organic composition forming a polymeric gel capable of forming a porous carbon monolith by pyrolysis, the composition being made of a resin at least partially obtained from polyhydroxybenzene(s) R and formaldehyde(s) F, said gelled composition comprising at least one water-soluble cationic polyelectrolyte P. Preferably, this polyelectrolyte will be an organic polymer selected from the group comprising the quaternary ammonium salts, poly(vinyl pyridinium chloride), poly(ethyleneimine), poly(vinyl pyridine), poly(allylamine hydrochloride), poly(trimethylammonium ethylmethacrylate chloride), poly(acrylamide-co-dimethylammonium chloride) and the mixtures thereof.

The curves of FIG. 9 showing the evolution of the gaseous thermal conductivity as a function of the pressure, for different porous materials. The values of 10 nm, 100 nm, 100 microns, etc. are the characteristic sizes of the pores of the porous material in question.

Thus, the curve 3 shows the case of a nanoporous material (aerogel), the curve 2 shows the case of a microporous material having pores of 1 micron and the curve 1 shows the case of a microporous material having pores of 100 microns.

With such blocks, it is possible to form a thermal insulator 5 with mechanically structuring effect (polyurethane can be an alternative, although notably less thermally efficient). One advantage of the pyrolysate of the composition presented in FR-A-2996850 is, however, that it is not inflammable.

Alternatively or additionally, a heat-reflective screen 41 may be contained in the enclosure 7, as shown in FIG. 7, in order to limit the radiative exchanges (thermal radiation) through the part. This can be a screen with multiple layers.

The metal heat-reflecting screen element 41 can be attached, including by welding, to at least one of the metal sheets 30, 31 in order to keep it in place inside the enclosure 7.

Thus, it is possible to contemplate protections in which the insulating function is provided by a sufficiently high vacuum (typically less than 10⁻¹ Pa) in conjunction with heat-reflecting films 500. These will advantageously be straps in which the reflection coefficient of the thermal waves (cf. table below), with wavelengths between 0.1 μm and 100 μm, will be high enough to stop the heat emitted by radiation by reflecting same. A relevant solution will comprise metal straps constituting a sleeve with an internal pressure <10³ Pa and one or more heat-reflective films with a total thickness of less than 300 mm. Each film should have very low emissivity: ideally <0.1. Another solution with a series of layers of aluminised Mylar™ and insulating felt is also possible.

It is known that the emissivity is equal to the absorption coefficient. And the transmission coefficient will be weak since a thin film absorbs less energy. Thus, low emissivity guarantees a good reflection coefficient and thus good protection against thermal radiation.

Regardless of the nature of the element 5, and even if an atmosphere, for example of CO2 in the enclosure 7, may be suitable in certain cases that are less demanding in terms of thermal insulation, it is considered that the pressure inside the enclosure will make it possible, despite everything, for the part 1 to reach truly low thermal conductivity. In practice, the pressure inside the enclosure 7 will thus be preferably comprised between 0.00001 mbar and less than 1000 mbar (1000 mbar=10⁵ Pa), early in life (in the year or months following production). In addition, with an internal pressure of 1 Pa, sheets and a core material 5 according to FR29966856 with a thickness of 10 mm and a leakage rate as mentioned above (typically 10⁻¹⁰ Pa·m³/s), the part 1 must guarantee an internal pressure of 10³ Pa (10 mbar) at most after at least ten years of service life, according to standard RTCA-DO 160-G section 5 Cat A (from −55° C. to 400° C.), with identical leakage rates (to within 20%) before the application of the test according to the standard and afterwards.

In this regard, it can be deduced from FIG. 6 that, if the maximum admissible pressure inside the enclosure 7, at the end or early life of the part 1, is set at 100 mbar, then no material with a porosity of more than 10 nm can be as efficient as the gel of the curve (2) and the pyrolysate thereof (curve 3), in relation to a core 5 made of PU (polyurethane); curve (1).

A low pressure inside the enclosure 7 will create a pressure difference that can reach 10⁵ Pa, between the outer environment and the enclosure 7. If there is any concern that the sleeve 3 cannot absorb this stress alone, a structuring core material 5 will help support the compression. Reinforcements made of this material may help further. These reinforcements can be shims or specific structures, such as honeycombs. If the or at least one of the plates 30, 31 is made of grained metal (produced, for example, by embossed rollers), thus having domes 57 as shown schematically in FIG. 10, it is also possible to improve the mechanical strength of the part 1.

One or more getters (or gas traps) may be provided in order to prevent the oxidation of the core material and to fix the gases that penetrate the enclosure 7 or that are emitted by the core 5 during the lifespan thereof. Each getter will make it possible to limit the pressure increase and to collect the moisture, hence its effect on conductivity.

Regardless, the part 1 will have, over a temperature range of −20° C. to 500° C., a thermal conductivity comprised between 10 mW/m·K and 100 mW/m·K, and preferably lower than 26 mW/m·K (air).

And according to a feature that is essential to the resistance of the panel over time as indicated above, the seal 6 of the metal sheet(s) of the sleeve, carried out in a controlled atmosphere, will have a leakage rate of less than 10⁻⁶ Pa·m³/s after a first thermal treatment according to standard RTCA-DO 160-G section 5 Cat A (from −55° C. to 400° C.) and a second thermal treatment at −196° C. during 1 hour. This at least rules out the possibility of the plates 30, 31 being lined with plastic, for example, and of there being no direct metal/metal sealing, each plate actually forming, in principle, the inner and outer limits of the sleeve 3.

The inner pressure of the enclosure 7 can thus be maintained for times of the order of ten years or slightly longer.

The leakage rate is expressed according to the following equation:

$$τ = Δ p admissible \cdot \frac{Volume under vacuum}{Lifespan}$$

Δpadmissible is the difference, in Pa, between the admissible end-of-life pressure in the part and the early-of-life pressure;
Volume under vacuum is the volume of the enclosure 7, in m³;
Lifespan is expressed in s.

For example, for a protection made up of an enclosure 7 with a volume of 1 litre in a vacuum, a lifespan of 3 years corresponds to a leakage rate of 10⁻⁸ Pa·m³/s. Below is a table listing the leakage rates and the lifespans for protecting a volume of 1 litre and an end-of-life pressure difference of 10 mbar.

| | | |
|---|---|---|
| 1.E-04 | 1 | day |
| 1.E-05 | 12 | days |
| 1.E-06 | 116 | days |
| 1.E-07 | 3 | years |
| 1.E-08 | 32 | years |
| 1.E-09 | 317 | years |
| Leakeage | | |
| rate | | |
| mbar.L/s | | |

The leakage rates are measured according to the following standards:
ISO 17025: General requirements for the competence of testing and calibration laboratories.
ISO 3530: Vacuum technology—Mass-spectrometer-type leak-detector calibration.

A helium test may be required if the leakage rate to be measured is lower than 10⁻⁴ Pa·m³/s. On top of this, an underwater air test may be used.

An important point will thus be made in connection with the type of seal 6 made.

FIG. 11 is a schematic view of the fact that the seal 6 is produced under a controlled atmosphere, directly in the inside volume 65 of a chamber 59 with controlled atmosphere in terms of pressure and/or composition.

Thus, in a favourable manner, the sealing step will comprise welding (continuous and without filler material, and thus different from simple brazing) between the first and second metal plates 30, 31, at least partially inside the chamber 65 with low pressure and/or controlled atmosphere. A portion of the weld may have been carried out beforehand, outside the chamber 65.

Thanks to a gas-evacuation system 61, the pressure inside is lower than 10⁵ Pa, preferably between 10⁻³ Pa and 10² Pa, and preferably still between 10⁻³ Pa and 10° Pa (primary vacuum). And thus, a sealing machine 63 was placed in this chamber 59 beforehand. After the adjusted low pressure is produced in the space 65, this machine will thus carry out this sealing in area 6, in a single continuous line, preferably where the plates are clamped together.

Alternatively or additionally, the system 61 may serve to replace the air with a gas having lower thermal conductivity than the ambient air (such as CO2) in the space 65 of the chamber 59.

It is thus also possible for only a portion of the continuous weld 6 to be produced inside the chamber 59, after continuous welding of a first part outside the chamber. Thus, it is possible to continuously weld three sides out of four in the solution of FIG. 1 outside the chamber 59, the fourth being continuously welded inside the closed chamber 59. What matters is that the controlled atmosphere of the chamber can reach the inside volume 7 before this space is entirely closed at the perimeter, via the weld 6.

Even if other types of welding can be considered, this seal will preferably comprise one among seam welding, electron-beam welding, diffusion welding, induction welding and micro-plasma welding, thus carried out with the adapted machine 63.

Thus, if a core material 5 is provided, and a bowl-shaped part as in FIG. 1 or 4 is sought, it will suffice, when the time comes:
to form the first and second metal plates 30, 31 so as to constitute the (at least locally) concave inner wall 30 and convex outer wall 31, respectively, of the finished part or of a blank thereof,
during these forming operations, the shapes of the plates are adjusted such that they can be placed in contact with one another, peripherally (typically via the flange 35), while leaving a space therebetween (volume 7, after sealing), inside said periphery,
to insert the core material 5 (or the screen 41) between these plates, before or after having placed the cavity of the first plate 30 inside the cavity of the second plate 31, so as to then define a double-walled volume,
to place the whole inside the chamber 59, the plates then being close enough together to be sealed together, directly, at the area 6, so that the enclosure 7 with low pressure and/or controlled atmosphere is created inside said space.

Then, the chamber 59 is opened and a ready-to-use part 1 is ready to be used.

It should be noted that, preferably, before sealing the plates, or even before placing the core material 5 between same, it will be moulded, for example in a lost-wax mould, substantially with the shapes of the inner and outer walls of the first and second metal plates 30, 31, respectively. It is also possible to pour a powder between the shaped plates 30, 31, and then to set said powder using a binder, so as to establish the shape of the core material 5.

As regards the forming of the plates 30, 31, it can be obtained preferably by incremental forming (ISF). Forming by stamping or moulding is also possible.

A heat exchanger and a storage tank can be cited among the foreseeable embodiments.

In each case, all or part of the walls of the exchanger or the tank will be formed like part 1. A useful inner volume of the exchanger or the tank will thus be thermally insulated from the outside environment.

The volume of the tank may be closed by an openable or detachable cover, also formed like a part 1.

In the exchanger, fluid inlets and outlets will allow the circulation of at least two fluids to be placed in thermal exchange inside the exchanger that the parts 1 will protect thermally, at the periphery. If the fluid inlets and outlets need to pass through at least one part 1, a seal will be provided around each passage, typically via a sealing bead.

In the “IFS” application, as in FIG. 12, a nacelle 69 comprises, along the longitudinal axis XX of the engine, after a median section 71 surrounding a fan 73 of the turbojet engine 75, a downstream section 77. The downstream section comprises an inner structure 79 (IFS), an outer structure (also referred to as outer fixed structure or OFS) 81 and a movable cover (not shown) including thrust reversal means. The IFS 79 and the OFS 81 are stationary relative to the movable cover. They define a flow section 83 allowing the passage of a stream of air 85 entering into the engine, in this case into the fan 73. The top of the nacelle accommodates a fastening pylon allowing the nacelle to be attached, typically, to a wing of the aircraft.

The parts 1 are arranged inside the inner structure 79 (IFS), each advantageously having an overall curved shape, in particular arched, considering the overall annular shape of said inner structure. An individual shape globally forming a ring sector is adequate for each part 1, the whole thus defining an annular shape, with sectors circumferentially from end to end. In this way, an embodiment with shell or bowl portions, as allowed by the manufacturing process presented above, is realistic.

In order to assemble a plurality of consecutive parts 1 together along the double wall 30, 31, instead of attaching them together end to end, it is possible to use intermediate connection elements inserted between two parts 1 and attached to same, at the flanges 22 or 35. These attachments can be made by screwing, welding or others.

1. A method for producing a thermally insulating part having inner and outer walls, respectively, the method comprising the following steps:
using at least one first and one second metal plates;
hollow-forming the first metal plate to constitute at least one portion of the inner wall of the finished part or of a blank thereof; and
hollow-forming the second metal plate to constitute at least one portion of the outer wall of the finished part or of a blank thereof;
wherein the method also comprises steps:
wherein the hollow-forming of the first metal plate is internally at least locally concave to constitute at least one portion of said inner wall,
wherein the hollow-forming of the second metal plate is externally at least locally convex to constitute at least one portion of said outer wall,
wherein the cavity of the first metal plate is placed inside the cavity of the second plate, in order to define a double-walled bowl,
during forming, the shapes of the first and second metal plates are adjusted such that they can be placed in contact with one another, peripherally, while leaving a space there between, inside said periphery, and
then the first and second metal plates are placed in a chamber with low pressure and/or controlled atmosphere, in which they are welded together, peripherally, with a continuous weld, so that an enclosure with low pressure and/or controlled atmosphere is created between them inside said space.

2. A method for producing a structure:
wherein a plurality of such thermally insulating parts are made, each part being made in a double-walled pan according to the method of claim 1, and,
wherein, once the parts are sealed, at least two such sealed parts are assembled together, arranging them facing one another to produce the structure, which comprises an inner space, between the double walls.

3. The method of claim 1, wherein before welding the first and second metal plates together in the chamber with low pressure and/or with controlled atmosphere, a thermally insulating core material is inserted therebetween.

4. The method of claim 3 wherein before welding the inner and outer walls together, the hollow core material is moulded, substantially to the shapes of the inner and outer walls of the first and second metal plates to be placed inside one another, respectively

5. The method of claim 1, wherein during the usage step, first and second metal plates with thickness from 0.07 mm to 3 mm are used, chosen from the group comprising stainless steel, aluminium and other metals with thermal conductivity of less than 300 W/m·K.

6. A thermal insulating part comprising an airtight casing defining an inner enclosure with low pressure relative to the outside environment or with a controlled atmosphere, the part having a thermal conductivity of less than 100 mW/m·K, at 20° C. and in an environment at atmospheric pressure, the airtight casing comprising inner and outer metal walls, respectively, sealed together peripherally to maintain the enclosure with low pressure or under a controlled atmosphere, and each having a thickness of less than 3 mm, characterised in that:
said seal is a continuous weld, and
the inner and outer metal walls, respectively, are both globally hollow-formed and arranged with one cavity inside the other, so as to jointly define a pan with double wall.

7. The part of claim 6, wherein the metal walls are surrounded by an attachment flange which comprises a mechanically reinforced structure, such as a frame:
located at least locally around the seal between the metal walls,
and which receives, around said seal, means for linking with a structure to which the part is added in order to be attached,
the attachment flange having an increased material thickness compared with the thickness of the metal walls, in order to define the mechanically reinforced structure and/or the seal between the metal walls.

8. The part of claim 6, wherein the airtight casing surrounds a core material comprising an organic or inorganic porous thermal insulator.

9. The part of claim 6, which defines at least one portion of a sump for receiving a fluid at a temperature ranging from −50° C. to 15° C. or from 50° C. to 300° C.

10. A heat store for a motor vehicle or naval propulsion engine, the heat store comprising the part of claim 7.

11. An aircraft engine nacelle comprising an inner fixed structure provided with a plurality of such insulating parts of claim 7, the insulating parts being assembled together and each having a curved shape.

12. (canceled)

13. (canceled)
